(19) United States
(12) Patent Application Publication
(10) Pub. No.: US 2015/0101740 A1
(43) Pub. Date: Apr. 16, 2015

(54) OFFSET PRINTING FOR HIGH-SPEED CORRUGATION APPLICATIONS

(71) Applicant: COLOR-BOX, LLC, ATLANTA, GA (US)

(72) Inventors: Sergio Morales Garcia de la Vega, Johns Creek, GA (US); Alex Norman Green, Marietta, GA (US)

(73) Assignee: COLOR-BOX, LLC, ATLANTA, GA (US)

(21) Appl. No.: 14/055,556

(22) Filed: Oct. 16, 2013

(51) Int. Cl. B31D 1/00; B31F 1/00

(52) U.S. Cl. CPC B31D 1/0093; B31F 1/0045; B31D 1/0075; B31D 1/0043
USPC 156/226; 156/277; 156/250; 156/387

(57) ABSTRACT

The present application provides systems, apparatus, and methods for providing high quality printed corrugated boxes through the use of a variable sleeve offset press. In one embodiment a method is provided comprising the steps of: printing a linerboard web to provide ink to the linerboard web. The printing step may comprise using an offset printing press having variable repeat length. The method may further comprise rewinding the printed linerboard web onto a roll; providing the printed linerboard web to a high speed corrugation machine via the roll; laminating the printed linerboard web to a fluted medium web thereby producing a printed corrugated web. The method may further comprise applying heat to at least one of the printed linerboard web and the fluted medium which causes heating of the ink on the linerboard web printed thereon by the offset printed press.

### BACKGROUND

The invention disclosed herein relates to methods, ink formulations, systems and apparatuses for using an offset printing press in combination with a high-speed corrugation machine.

Printed corrugated paperboard is a popular packing material for a wide variety of products. Corrugated paperboard typically comprises a corrugated or fluted medium and a linerboard laminated to one or both sides of the fluted medium. One or both of the linerboards can be printed to provide a decorative appearance to the final product, which is important in consumer-facing boxes made from corrugated paperboard.

As a result, methods of rapidly producing corrugated paperboard have been developed using the application of heat. For example, heat can be applied to the medium in order to allow the corrugation processes to run efficiently at higher speeds and to activate the starch-based adhesive used to adhere the layers together. The printed linerboards are then laminated to the fluted medium. Due to the heat used in the high speed corrugation process, care must be taken to ensure the ink on the printed linerboard is sufficiently dried and/or cured. If the ink is not sufficiently dried or cured, or if the ink is of improper formulation, the heat involved in high-speed corrugation may cause the ink to breakdown or smear, degrading the quality of the print.

Flexographic printing processes are generally used to print the linerboard for high speed corrugation applications. The relatively low viscosity ink used for flexographic printing allows the ink, and any applied coatings, the necessary time to dry and/or cure in a time frame appropriate for high speed corrugation applications. However, flexographic printing can be expensive and is usually considered to have inferior quality as compared to offset printing.

Offset, or lithographic, printing is known to be an efficient printing process in commercial applications, such as printing newspapers and books. However, offset printing has proven to be ineffective in high-speed continuous web corrugation applications where the linerboard is fed to the fluted medium. Offset printing requires a higher viscosity ink than flexographic printing, and therefore the ink and any applied coatings require longer drying times. Also, the repeat length of offset printing presses is often set and unchangeable. Thus, printing boxes of different sizes using web-fed offset printing process can be quite complicated. For printing operations where the same repeat length is used for long runs, such as paperboard for cereal boxes, this is less of an issue. However, for small print runs where color corrugated boxes are used for discrete or custom consumer uses, or low volume products, it would be advantageous to provide for high-speed, yet variable length printing processes and apparatus.

Therefore, there is a need in the art for methods, systems, and apparatus for offset printing processes for high-speed web-fed corrugation applications.

### SUMMARY

The present invention provides methods, systems, and apparatus for providing high quality printed corrugated webs, boxes, and the like. In various embodiments, a variable repeat length offset press is used to print a high quality printed linerboard. A coating and curing process may be performed to prevent degradation of the ink used to print the printed linerboard. The printed linerboard may be provided via a roll to a corrugation system, such as a high speed corrugation system. The printed linerboard may be bonded onto a fluted medium, a fluted medium on the open side of a single-faced web, and/or the like, resulting in a high quality printed corrugated web. The web may then be cut into box blanks or corrugated sheets and/or converted into high quality printed corrugated boxes.

According to one aspect of the present invention, a method for producing high quality printed corrugated boxes is provided. In various embodiments, the method comprises printing a linerboard web to provide ink to the linerboard web and in particular comprises using an offset printing press having a variable repeat length. The method may further comprise: rewinding the printed linerboard web onto a roll; providing the printed linerboard web to a high speed corrugation machine via the roll; laminating the printed linerboard web to a fluted medium web thereby producing a printed corrugated web. The method may further comprise applying heat to at least one of the printed linerboard web and the fluted medium which causes heating of the ink on the linerboard web printed thereon by the offset printed press.

According to another aspect of the present invention, an apparatus for producing high quality printed corrugated boxes is provided. In various embodiments, the apparatus may comprise a printing press component configured to provide ink to a linerboard web, thereby producing a printed linerboard web. The printing press component may be an offset printing press having a variable repeat length. The apparatus may further comprise: a winding component configured to wind the printed linerboard web onto a roll; an infeeding component configured to feed the printed linerboard web from the roll into a high speed corrugation component; and a laminating component configured to laminate the printed linerboard web onto a fluted medium, thereby producing a printed corrugated web. At least one of the high speed corrugation component and the laminating component are further configured to apply heat to at least one of the printed linerboard web and the fluted medium which causes heating of the ink on the linerboard web printed thereon by the printing press component.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic view of an offset printing system in accordance with one embodiment of the present invention;

FIG. 2 illustrates a schematic view of one embodiment of a corrugation system, in accordance with the present invention; and

FIG. 3 is a flow diagram of a method of providing high quality printed linerboard web for use in high-speed corrugation applications, in accordance with at least one embodiment of the present invention.

### DETAILED DESCRIPTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Overview

The present invention provides systems, apparatus, and methods for producing high quality printed corrugated boxes. An offset printing system is used to provide a high quality printed linerboard web. In various embodiments, the offset printing system may comprise a variable sleeve offset press and may rewind the printed linerboard web onto a roll such that the linerboard web may be provided to a corrugation system via the roll. Providing the linerboard web to the corrugation system via a roll simplifies the time-synchronization issues provided by the speed difference between the offset printing system and the corrugation system if the offset printing system and the corrugation system were run together inline. In various embodiments, the corrugation system may be configured to provide a fluted medium and laminate (e.g., glue, paste, and/or otherwise attach) the fluted medium to at least one linerboard web providing a high quality printed single-faced or double-faced corrugated web. In various embodiments, the corrugation system may comprise a high speed corrugator. Various embodiments of the invention are described below. The embodiments described herein are provided as non-limiting, illustrative examples.

### Offset Printing System 100

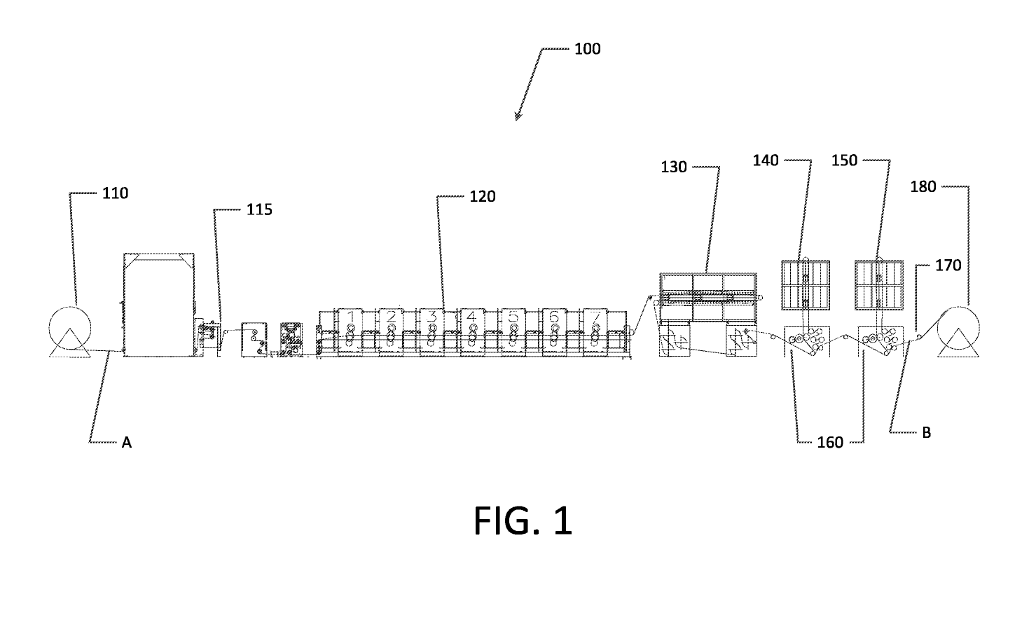

Various embodiments of the present invention comprise an offset printing system 100. FIG. 1 illustrates an example embodiment of an offset printing system 100. Starting from the left side of FIG. 1, an unprinted front linerboard web A is fed into the offset printing system 100 via web feeding device 110. In some embodiments, such as the embodiment illustrated in FIG. 1, infeed equipment 115 may be configured to control the tension in the unprinted front linerboard web A. Some embodiments may not comprise infeed equipment 115 and the tension in front linerboard web A may be controlled via other mechanisms or methods. Once the unprinted front linerboard web A is fed into offset printing system 100, the unprinted front linerboard web A is fed into an offset press 120.

In the example embodiment illustrated in FIG. 1, the offset press 120 is a variable sleeve wide-web offset press, such as the Sunday VPAC 3000 by Goss International. The variable sleeve offset press 120 allows for printing at different repeat lengths up to, for example, 55 inches. By varying the thickness of the print sleeve, the circumference of the printing cylinder may be changed, and therefore the repeat length may be changed to accommodate various printing jobs. The variable repeat length allows the same press to be used for the printing of boxes of different sizes. In the embodiment illustrated in FIG. 1, seven offset press units are used to apply ink to the front linerboard A. In various embodiments, various numbers of offset press units may be employed. The offset press 120 may be configured to accommodate wide webs, such as webs around 75 inches in width. In various applications, wider or narrower webs may be used, as appropriate for the application. The ink used by offset press 120 may be specifically formulated to withstand the heat encountered by the printed front linerboard web B during the high-speed corrugation process.

The ink may be dried or cured onto the printed front linerboard web B in a variety of ways depending on the formulation of the ink to be used by the offset press 120. In some embodiments, the offset printing system 100 may be configured to allow the ink to dry via absorption and/or evaporation, by providing sufficient time in acceptable conditions. In various embodiments, the offset printing system 100 may comprise a curing component 130 to assist in the setting of the ink. In various embodiments, the curing component 130 may dry the ink used by the offset press 120 to print the front linerboard web B. In some embodiments, curing component 130 may aid the evaporation and/or absorption of the ink from and/or into the front linerboard web B. In other embodiments, curing component 130 may be configured to heat cure, UV cure the ink, or cure the ink by some other mechanism.

In various embodiments, the offset printing system 100 may further comprise one or more coating applicator components 160. In such embodiments, the coating applicator component 160 is configured to apply a coating to the printed front linerboard web B. In some embodiments, the applied coating may be configured to protect the ink from degradation or smearing due to the heat used in high-speed corrugation applications. In other embodiments, the applied coating may be configured to protect the printed linerboard of the finished box from visible wear. In some embodiments, the applied coating may be configured to provide the printed front linerboard web B with a semi-gloss, gloss, high gloss, or other finish. In the illustrated embodiment of FIG. 1, the first one of the coating applicator components 160 could apply an aqueous coating, and the successive coating applicator component 160 could apply a UV coating.

In embodiments of the offset printing system 100 comprising coating applicator components 160, the offset printing system 100 may further comprise coating drying components 140 and 150. In such embodiments, the coating drying components 140 and 150 may be configured to dry the coatings. In other such embodiments, the coating drying components 140 and 150 may be configured to cure the coating via heat curing, UV curing, or some other curing mechanism. In some embodiments, ink curing component 130 and coating drying components 140 and 150 may be implemented as a single component located downstream from the coating applicator component 160. Some embodiments of the offset printing system 100 may not comprise a coating drying component 140/150

In various embodiments, such as the embodiment illustrated in FIG. 1, one or more web feeder devices may be configured to control the tension in the printed front linerboard web B as the web is fed through the offset printing system 100. In various embodiments, the web feeder device may take a variety of forms, depending on the application. After the coating drying components 140 and 150, the printed, cured, and possibly coated front linerboard web B is then fed to rewinding component 170. The rewinding component 170 is configured to roll the front linerboard web B onto roll 180 such that the front linerboard web may be easily fed into a corrugation system 200. By providing the front linerboard web B to the corrugation system 200 via a roll, rather than printing the front linerboard web B in line with the corrugation system 200, the complications of speed-synchronizing the offset printing system 100 and the corrugation system 200 may be mitigated. Speed-synchronizing the offset printing system 100 and the corrugation system 200 may be especially complicated in embodiments in which offset press 120 is a variable sleeve offset press due to the variable repeat length of the pattern printed by the variable sleeve offset press.

### Various Embodiments of Corrugation System 200

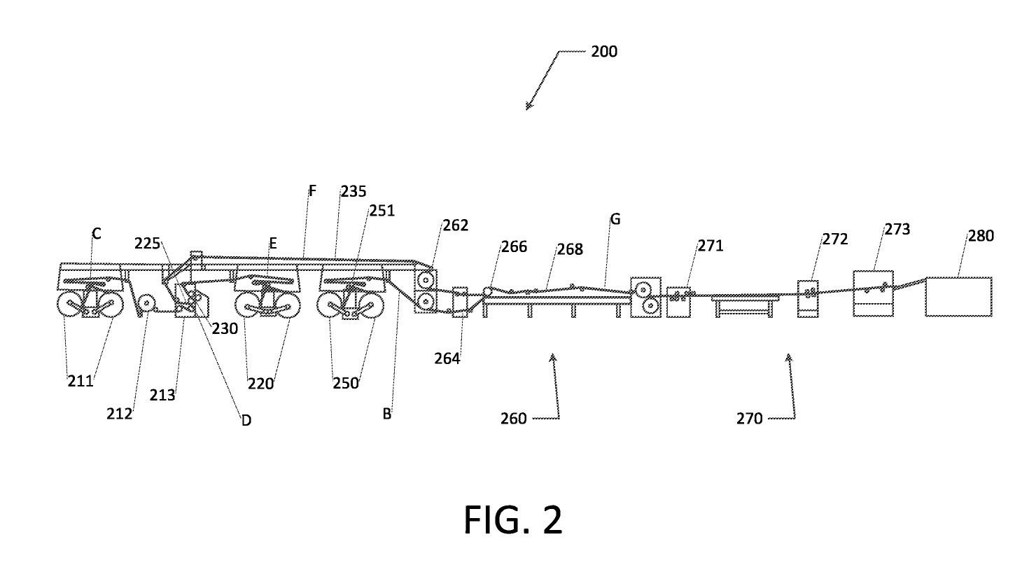

In various embodiments, a corrugation system may be configured to bond or laminate a printed linerboard B onto a fluted medium or the fluted medium on the open side of a single face web, and/or the like. The corrugation system may be configured to corrugate a medium web, thereby producing the fluted medium. In various such embodiments, the corrugation system 200 may comprise a high-speed corrugator, as is generally known in the art. The embodiment of a corrugation system 200 illustrated in FIG. 2 will now be described.

FIG. 2 shows an embodiment of a corrugation system 200 wherein the corrugation of the fluted medium D is completed inline. The fluted medium D may be any fluted medium appropriate for the application. The uncorrugated medium E is provided to the corrugation system 200 via one or more rolls loaded onto roll stand 220. The uncorrugated medium E is fed into a corrugator 213. The uncorrugated medium E is corrugated or fluted as it runs over the heated corrugator rolls 230, thereby producing the fluted medium D. The heat may be applied to the corrugator rolls 230 in any suitable form, including but not limited to the use of steam, electric resistance elements like belts or plates, or fuel combustion. In various embodiments, the corrugator 213 may be a high-speed corrugator. The fluted medium D is then fed to the single-facing component 225, as the top linerboard web C is fed into the single-facing component 225 via one or more rolls loaded onto unwinding stand 211 and the pre-heater roller 212.

As noted, A linerboard web C is fed into the corrugation system 200 off of one or more rolls loaded onto unwinding stand 211. The linerboard web C is run over pre-heater roller 212 before being fed into the single-facing component 225. The pre-heater roller 212 may be configured to supply heat to the linerboard web C as appropriate for the application. The single-facing component 225 then laminates the linerboard web C to the fluted medium D, as is generally known in the art, thereby producing a single-faced web F. In various embodiments, such as that illustrated in FIG. 2, the corrugation system 200 may further comprise a bridge 235, which allows the single-faced web F to cool. In various embodiments, the bridge 235 may be configured to cool, cure, and/or dry the single-faced web F. The cooling and drying may be caused by exposure to unforced ambient air, or by way of apparatus that accelerates cooling or drying relative to ambient air. In various embodiments, the bridge 235 may also provide a mechanism by which the difference in speed between the single-facing component 225 and the double-facing component 260 may be accommodated.

Once the single-faced corrugated web F is sufficiently dry, cured, and/or cool, the single-faced corrugated web F may be fed into the double-facing component 260 via pre-heater roller 262. The pre-heater roller 262 may be configured to supply heat to the single-faced web F, as appropriate for the application. The single-faced web F may then be fed through the double-backer glue machine 264 where adhesive may be applied to the exposed flute tips.

In various embodiments, as the single-faced web F is fed into the double-facing component 260, the printed front linerboard web B, which was printed by the offset printing system 100, may be fed into the corrugation system 200 from one or more rolls loaded onto roll stand 250 via printed front linerboard web infeeding component 251. Particularly, the front linerboard web B may be fed into the double-facing component 260 via a pre-heater roller 262. The pre-heater roller 262 may be configured to supply heat to the printed linerboard web B as appropriate for the application. The printed linerboard web B may then pass through the double-backer glue machine 264. In some embodiments, the double-backer glue machine 264 is configured to apply an adhesive to both the single-faced web F and the printed linerboard web B. In other embodiments, the adhesive is applied to only one of the single-faced web F and the printed linerboard web B. In various embodiments, the adhesive is a starch adhesive. The single-faced web F and the printed linerboard web B are brought into contact with each other by nip roller 266 such that the exposed flute tips of the fluted medium are in contact with the non-printed side of the printed linerboard web B.

The combined single-faced web F and printed linerboard web B are passed over hot plate section 268. The applied heat activates an adhesive, such as a starch-based adhesive, that is applied to the fluted medium. The temperature, which may be as high as 350° F., turns the adhesive into a gel consistency. The hot plate section 268 may be further configured to cure the adhesive. Thus, as the combined single-faced web F and printed linerboard web B pass over hot plate section 268, the adhesive laminates the single-faced web F to the printed linerboard web B, thereby producing a combined board web G.

As may be appreciated from the embodiment illustrated in FIG. 2, the printed linerboard web B may be fed into the corrugation system 200 such that the printed side of the printed linerboard web B is facing downward. Thus, the printed side of the printed linerboard web B may be in direct contact with the hot plates comprising the hot plate section 268. Thus, the printed side of the printed linerboard web B experiences heat and/or friction during the laminating process that may cause significant damage to the print quality of the printed linerboard web B. A coating, such as that discussed above, may be applied to the printed linerboard web B prior to supplying the printed linerboard web B to the corrugation system 200 to protect the ink printed onto the printed linerboard web B, in various embodiments.

In various embodiments, the combined board web G is fed downstream from the hot plate section 268 to a cutting component 270. The cutting component 270 may comprise one or more rotary shears, one or more slitters, one or more scorers, one or more knife cylinders, and/or the like. The cutting component 270 may be configured to slit, score, and/or cut the combined board web G into web portions such as individual boxes, sets of boxes, and/or the like as appropriate for the application. In various embodiments, the cutting component 270 may be configured to slit, score, and/or cut the combined board web G across the width of the web and/or in the direction of advancement of the web. For example, the slitter/scorer component 271 may be configured to slit and/or cut the combined board web G in the direction of the advancement of the web. The slitter/scorer component 271 may be further configured to score the combined board web G to facilitate later folding. Cross cutting component 272 may be configured to cut the combined board web G in a direction transverse to the advancement direction of the web, thereby producing sheets of combined board. Additionally, stacking component 273 may be configured to stack the sheets of combined board. Thus, in various embodiments, the cutting component 270 may be configured to slit, score, and/or cut the combined board web G into individual box blanks that are then stacked by the stacking component 273. In various embodiments, the sheets of combined board G may be fed downstream to a converting component 280 that may receive the individual box blanks and fold them into individual boxes.

In various embodiments, the corrugation system may be configured to provide printed single-faced, double-walled, or triple-walled webs, corrugated sheets, box blanks, and/or boxes. In some embodiments, the interior of the resulting box may also be printed. In order to provide a printed single-faced web, the linerboard C is replaced by printed linerboard B and the second linerboard is omitted. In some embodiments, the single-faced web may be cut into lengthy strips that may be folded onto themselves in an accordion-like manner and stacked onto a pallet or the like, rather than being cut into corrugated sheets, box blanks, or converted into boxes. To provide double-walled corrugated sheets, box blanks, and/or boxes, an additional single-facing component may be added to the corrugation system illustrated in FIG. 2. Thus, a second linerboard C will be laminated onto a second fluted medium D. The open side of the second fluted medium D may be laminated to the first linerboard C opposite the first fluted medium D. To provide triple-walled corrugated sheets, box blanks, and/or boxes, a third single facing component may be added to a double-walled embodiment of the corrugation system. The third single-facing component will laminate a third linerboard C may be bonded to a third fluted medium D. The third fluted medium D may then be bonded to the open side of the second linerboard C. In some embodiments, the interior and exterior of the resulting box may be printed. In such embodiments, the linerboard C that would become the interior wall of the box may be exchanged for a printed linerboard B. In some embodiments, the corrugation system may be configured to receive a pre-fluted or pre-corrugated medium, rather than fluting or corrugating the fluted medium in line, as in the embodiment illustrated in FIG. 2. As should be understood from the disclosure herein, a variety of high quality printed corrugated boxes, box blanks, and/or sheets may be provided by various embodiments of the present invention.

### Method for Offset Printing for High-Speed Corrugation Applications

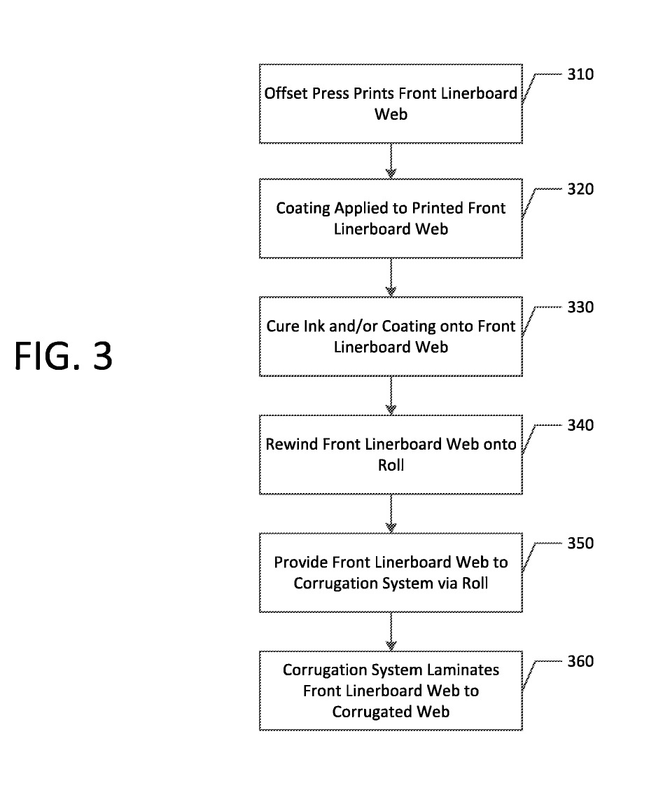

FIG. 3 is a flow diagram illustrating a method of offset printing for high-speed corrugation applications, according to various embodiments of the present invention.

At step 310 an offset printing system comprising an offset press is used to print the front linerboard web B. In various embodiments, the offset press may be a variable sleeve offset press. In various embodiments, the offset press may use cold set ink, heat cured ink, UV cured ink, or some other acceptable ink. The ink may be configured to not break down or smear from the heat used in the high-speed corrugation process.

At step 320 an offset printing system 100 or other system may apply a coating to the printed front linerboard web B. In various embodiments, the coating may be formulated to protect the ink used to print the front linerboard web B from degradation or smearing during the high-speed corrugation process. In other embodiments, the coating may be configured to protect the printed linerboard of the finished box from mechanical damage, such as scratching or wear. In some embodiments the coating may be used to apply a semi-gloss, gloss, high gloss, or other finish to the printed linerboard.

At step 330 the ink and/or coating are dried. In various embodiments, the step of drying the ink or coating may comprise heat curing or UV curing the ink and/or coating. In some embodiments, the ink may dry or be cured before the coating is applied.

At step 340 the printed front linerboard web B is rewound onto a roll or the like. The front linerboard web B may then be supplied to a corrugation system 200 via the roll or the like, at step 350. By providing the front linerboard web B to the corrugation system 200 via a roll or the like, the time synchronization complications caused by the difference in speed between the offset printing system 100 and the corrugation system 200 may be circumvented. The time synchronization of the offset printing system 100 and the corrugation system 200 is particularly complicated when the offset printing system 100 comprises a variable sleeve offset press due to the variable repeat length of the pattern printed by the variable sleeve offset press.

At step 360 the corrugation system 200 laminates the printed front linerboard web B onto a fluted medium D, producing a printed corrugated web (e.g., combined board G). The printed corrugated web may then be cut and scored to create box blanks.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for producing high quality printed corrugated boxes, the method comprising the steps of:
printing a linerboard web to provide ink to said linerboard web, wherein said printing step comprises using an offset printing press having a variable repeat length;
rewinding the printed linerboard web onto a roll;
providing the printed linerboard web to a high speed corrugation machine via the roll;
laminating the printed linerboard web to a fluted medium web thereby producing a printed corrugated web,
wherein the method further comprises applying heat to at least one of the printed linerboard web and the fluted medium which causes heating of the ink on the linerboard web printed thereon by the offset printed press.

2. The method of claim 1 further comprising the step of curing the ink.

3. The method of claim 1 further comprising the step of applying a coating to the printed linerboard web over the ink.

4. The method of claim 3 further comprising the step of curing the coating.

5. The method of claim 1 further comprising the step of laminating a linerboard web onto the fluted medium web.

6. The method of claim 1 further comprising, after the laminating step is complete, cutting the printed corrugated web into individual box blanks.

7. The method of claim 6 further comprising folding the individual box blanks into individual boxes.

8. The method of claim 1 wherein the ink is formulated to withstand the heating experienced by the ink due to heat applied to the fluted medium web during a process of corrugating the fluted medium web.

9. The method of claim 1 wherein the ink is formulated to withstand the heating experienced by the ink due to heat applied to at least one of the fluted medium web and the printed linerboard web to activate adhesive used to laminate the printed linerboard web to the fluted medium web.

10. The method of claim 1 wherein the offset printing press has a variable repeat length of up to 55 inches

11. The method of claim 1 wherein the offset printing press is configured to accommodate webs up to approximately 75 inches in width.

12. An apparatus for producing high quality printed corrugated boxes, the apparatus comprising:
a printing press component configured to provide ink to a linerboard web, thereby producing a printed linerboard web, wherein said printing press component is an offset printing press having a variable repeat length;
a winding component configured to wind said printed linerboard web onto a roll;
an infeeding component configured to feed said printed linerboard web from said roll into a high speed corrugation component;
a laminating component configured to laminate said printed linerboard web onto a fluted medium, thereby producing a printed corrugated web,
wherein at least one of the high speed corrugation component and the laminating component are further configured to apply heat to at least one of the printed linerboard web and the fluted medium which causes heating of the ink on the linerboard web printed thereon by the printing press component.

13. The apparatus of claim 12 further comprising an ink curing component configured for curing said ink.

14. The apparatus of claim 13 wherein the winding component is located downstream of said ink curing component.

15. The apparatus of claim 12 further comprising a coating applicator component configured to apply a coating to said printed linerboard web over said ink.

16. The apparatus of claim 15 further comprising a coating curing component configured for curing said coating.

17. The apparatus of claim 12 further comprising a second laminating component configured to laminate a top linerboard web onto said fluted medium web.

18. The apparatus of claim 12 further comprising a cutting component located downstream of said laminating component and configured to cut said printed corrugated web into individual box blanks.

19. The apparatus of claim 18 further comprising a converting component configured to fold said individual box blanks into individual boxes.

20. The apparatus of claim 12 wherein the ink is formulated to withstand the heating experienced by the ink due to heat applied to the fluted medium web during a process of corrugating the fluted medium web.

21. The apparatus of claim 12 wherein the ink is formulated to withstand the heating experienced by the ink due to heat applied to at least one of the fluted medium web and the printed linerboard web to activate adhesive used to laminate the printed linerboard web to the fluted medium web.

22. The apparatus of claim 12 wherein the offset printing press has a variable repeat length of up to 55 inches.

23. The apparatus of claim 12 wherein the offset printing press is configured to accommodate webs up to approximately 75 inches in width.
